(19) United States
(12) Patent Application Publication
(10) Pub. No.: US 2012/0061326 A1
(43) Pub. Date: Mar. 15, 2012

(54) Method for the Environmental Remediation of Oil Spills and Other Chemical Contaminants

(76) Inventors: Christopher Cox, Kingwood, TX (US); Stanley Dudek, Galveston, TX (US)

(21) Appl. No.: 13/233,009

(22) Filed: Sep. 14, 2011

Related U.S. Application Data
(60) Provisional application No. 61/382,647, filed on Sep. 14, 2010.

(51) Int. Cl. C02F 1/28; C02F 1/40; B01D 17/02; E02B 15/04

(52) U.S. Cl. 210/693; 210/691; 210/660

(57) ABSTRACT

Lipophilic, oil-absorbing and oil-adsorbing polymeric compositions are used to capture oily substances and hydrophobic materials from the surface of various aqueous media. The resultant compound floats in water, can be easily removed therefrom and can be processed in conventional refinery processes to recover the oil and the remaining components.

### RELATED PRIORITY DATE APPLICATION

This application claims the benefit under 35 U.S.C. 119(e) of the U.S. provisional application No. 61/382,647 filed on Sep. 14, 2010.

### TECHNICAL FIELD OF THE INVENTION

The present invention relates to the field of environmental remediation and, more particularly, to compounds and a method for the removal and recovery of oil and other hazardous substances from water. Still more particularly, the present invention relates to a method wherein certain polymeric compositions prepared from hydrophobic polymers are used to remove oily substances and other hydrophobic contaminants from an aqueous medium. The polymeric compositions combined with the removed oily substances and other contaminants may be processed through conventional refinery processes to recover the oil and the remaining components.

### BACKGROUND OF THE INVENTION

The huge demand for petroleum as a source of energy and as a primary raw material for the petrochemical industry is well known. In order to satisfy this demand, offshore oil drilling and production throughout the world is widespread and oil wells have been drilled and are producing in very deep waters wherein the risk of blowouts and other failures is very high. Further, in order to satisfy the demand in parts of the world where the oil consumption exceeds the local production, large tankers and underwater pipelines are used to transport oil from one part of the world to another.

These activities in the production, refining and distribution of crude oil have brought with them an ever-increasing problem of environmental pollution. A major portion of such pollution is attributed to the massive movements of crude oil and petroleum products by tankers. Because of accidents and/or intentional acts involving those tankers, large quantities of crude oil and petroleum are released onto oceans, seas, bays, estuaries, and other waterways. Another portion of such pollution is attributed to offshore oil drilling and production platform accidents that, oftentimes are difficult to contain before a large amount of crude is released and finds its way to the shore or the bottom of the ocean.

It is well known that oil pollution of the ocean and waterways can cause extensive ecological and economic damage by harming aquatic life, polluting municipal water sources, recreational beaches, boats, fish and harbors, and by interfering with a wide variety of aquatic recreational activities. Further, such pollution presents a serious problem to the public health due to the direct and indirect exposure of humans to the pollutants.

Another source of pollution are the non-petroleum organic contaminants which can be generated from various sources including organic and inorganic contaminants which can be found in industrial waste produced by, among other sources, carpet and textile mills, pulp and paper mills, commercial kitchens, food processing plants and the like.

In general, the term oil spill means the physical presence of an oil or an oil-product floating on fresh or salt water. The water body can be the high seas, lakes, streams, tanks, harbors, sewage-treatment facilities and the like. There presently exist several methods of environmental remediation of polluted waters from oil spills. One method involves the burning of the spilled oil. The burning process is difficult to implement because of the presence of water and hazardous effects to those performing the burning. Further, burning causes extensive air pollution with adverse effects on the climate can be effected by such burning.

Another method of remediating oil spills involves the degradation of petroleum substances through micro-organisms and chemical processes into relatively harmless substances. Another method utilizes dispersion aids such surfactants or soaps to disperse the oil. One disadvantage of these methods is that the oil is not removed from nature and remains therein in one form or another. For example, in the case of the use of the micro-organisms, the process is slow and significant environmental damage occurs before significant degradation occurs. In the case of chemical dispersion, the process does not remove the oil from nature; instead, it spreads it over a wider aquatic area thereby bringing it into contact with more marine life and aquatic birds. In cases wherein the spill is close to the shore, the dispersed oil is likely to contact the shore, where it will cause unsightly conditions and harm.

Another method used to treat oil spills utilizes chemicals that increase the specific gravity of the spilled oil to cause it to sink so that it cannot been seen on the surface of the water. Similarly, absorbent materials which are heavier than water have been used to absorb the oil, but these sink to the bottom, and retain the oil at the bottom of the sea. These sinking methods are not desirable because they retard degradation of oil by aerobic bacteria, and incorporate it into underwater sediment, where it can be preserved for long periods of time spread over a wider distance and adversely affect sea organisms. Valuable forms of life such as shrimp, shellfish, fish and the like can be wiped out or harmed by introducing oil into their fragile habitations.

Absorbent materials which do not sink in the water have attracted more interest for the removal of oil and other chemicals from water because they physically remove the contaminants from the environment. These are typically used in a sock type container for use as a boom. Most of the prior art material absorbs water whereby their removal performance is reduced. Further, because of their composition, they cannot be processed to recover the oil and be recycled for further use.

U.S. Pat. No. 4,780,518 discloses the use of a composition that be utilized to absorb water-insoluble organic liquids, particularly oil spills. The composition is a dry hydrophobic, lipophilic absorbent material comprising an absorbent substrate which is a polymeric carbohydrate in powder and a complex which is formed from, among other things, at least one fatty acid, one water-soluble hydroxide or oxide or salt, an ammonium ion donor and an alkaline metal hydroxide. The surface layers of the water-insoluble organic liquid floating on water, such as oil, is contacted with the said composition that absorbs the organic liquid thereon. Then, the absorbed material is removed through the use of a solvent. The presence of the solvent renders the recycling of the material undesirable or the reuse thereof less efficient.

U.S. Pat. No. 5,688,843 discloses a cross linked polymer that may be used to absorb oil from a water environment. U.S. Pat. No. 6,770,285 discloses an emulsion polymer which is used to absorb oil. U.S. Pat. No. 3,843,306 discloses the use of foamed silicate particles to remove oil from water. U.S. Pat. No. 5,700,558 the use of a biodegradable absorbent material for oil spills that consists of a mixture of granulated foam, microbial nutrient, de-dust agent and ground cellulosic material. U.S. Pat. No. 4,039,489 a cross linked polymer for absorbing oil.

One disadvantage of the use of the compositions disclosed in those patents as oil absorbents is that they cannot be recycled, reused or refined. In the case of fabric substrates, the oil material absorbed therein cannot be removed unless solvents are used. Accordingly, the compositions with the absorbed oil are sent to landfills or are burned. In the case of polymers used in the past to recover oil, they cannot be recycled through a standard refining process with the oil absorbed therein whereby they need to be disposed of by sending them to landfills or by burning them.

According to the present invention, a composition is used to remove oil and other hydrocarbons from water media and the resultant mixture can be easily recovered and processed in conventional refinery units thereby eliminating the need of disposal. These and other advantages and objects of the invention will become apparent from the following description.

### SUMMARY OF THE INVENTION

Lipophilic, oil-absorbing and oil-adsorbing polymeric compositions are used for capturing oily substances and hydrophobic materials from the surface of various aqueous media. The resultant compound is in the form of a defined pasty material that floats in water, retains very little water and can then be easily removed from the water body leaving behind an environment free of oil or other undesirable hydrocarbons. Upon removal from the water, the compound comprising of the polymeric composition and the absorbed and adsorbed oil can be fed to the front end of a refinery and be processed therein as if it were heavy oil to be broken into light and heavy material for further processing downstream to separate and recover the individual components for further use.

The polymer backbone of these polymers has a weight average molecular weight in the range from 100 to 6,000,000 and, preferably, in the range from 250 to 100,000. Their melting point is less than 200° C. They are used in fine particulate form and have a surface to volume ratio greater than 3.0.

The polymeric material used in accordance with the present invention in powder or ground form are placed in contact with the oil to be removed from the aqueous environment by spraying or other conventional techniques. The said polymeric particles selectively associate with the oil, absorb the oil, and form a lighter than water compound that can be easily separated from the water.

The amount to be used to remove the oil depends on the amount of oil present in the water and in every situation a sufficient amount is added to remove the oil.

### DETAILED DESCRIPTION OF THE INVENTION

According to the present invention, lipophilic, oil-absorbing and oil-adsorbing polymeric compositions are used for capturing oily substances and hydrophobic materials from the surface of various aqueous media including surfaces of bodies of salt water. The resultant compound which consists of the said polymeric composition and the absorbed and adsorbed oil is in the form of a defined pasty material that floats in water, retains very little water and can then be easily removed from the water body by skimming or similar methods leaving behind an environment free of oil or other undesirable hydrocarbons.

Upon removal from the water, the compound comprising of the polymeric composition and the absorbed and adsorbed oil does not require burning or disposal in a landfill. Instead, it can be fed to the front end of a refinery and be processed therein as if it were heavy oil to be broken into light and heavy material for further processing downstream to separate and recover the individual components for further use.

The polymeric compositions used in accordance with the present invention to absorb and adsorb the oil are hydrophobic low molecular weight polymers which are also known as hydrophobic waxes. The polymer backbone of these polymers has a weight average molecular weight in the range from 100 to 6,000,000 and, preferably, in the range from 250 to 100,000. The polymers with a polymer backbone of a weight average molecular weight in the preferred range from 250 to 100,000 have the most desirable absorbing capacity. Weight average molecular weights as used herein are measured using gel permeation chromatography (GPC) with styrene as a standard and are expressed as weight average molecular weight.

The melting point of the polymers used to absorb the oil in accordance with the present invention is less than 200° C. They are used in fine particulate form for enhanced oil absorption characteristics and have a surface to volume ratio greater than 3.0. They have the ability to absorb and/or adsorb at least 20 weight percent of an oily substance or hydrophobic material based on the total weight of the polymeric composition.

In order to have the desired absorption capability, the polymers are prepared for use in ground or powder form so as to have high surface area and a high surface area to thickness ratio. This is achieved by various mechanical methods including, but not limited to, grinding, chopping, spray atomization and by casting thin films. The preferred size is between 325 mesh and 6 mesh.

The polymers used herein are produced by refining from petroleum, by free radical polymerization of by extracting from natural substances. Examples of such polymers are polyethylene that can be any ethylene homopolymer or copolymer in powder or ground form that has a surface to volume ratio greater than 3, fine particles of paraffin wax which are routinely refined from crude oil by conventional refining techniques and natural polymers from plant or animal oils, polystyrene and poly alpha olefins.

The polymeric material used in accordance with the present invention in powder or ground form are placed in contact with the oil to be removed from the aqueous environment. This can be done by spraying or other conventional techniques. The said polymeric particles selectively associate with the oil, absorb the oil, and form a lighter than water compound that can be easily separated from the water by skimming, filtering or other similar methods.

The amount to be used to remove the oil depends on the amount of oil present in the water and in every situation a sufficient amount is added to remove the oil. Because of the absorbing capabilities of the material in question, the amount to be used is not large and may be in the range of from about 0.5 to about 5 pounds of material per pound of oil to be removed.

The mixture of polymeric material and oil removed form the water is suitable for processing in a conventional refinery by passing it through the catalytic process to separate the mixture to its individual components for further use downstream. As a result, there is no need for the undesirable disposal of polymeric material with the absorbed oil.

The following examples further illustrate the invention but are not to be construed as limitations on the scope of the invention contemplated herein.

### EXAMPLE 1

One quart of motor oil was poured into a container of water. A layer of oil was quickly formed on the surface of the water. Polyethylene powder with a mesh size of between 8 and 40 and a surface to volume ratio greater than 3 was then added on top of the oil in the container. The contents of the container were agitated. After agitation was stopped, the oil quickly and selectively coated the surface of the polyethylene powder and separated from the water. The polyethylene oil mixture was easily removed from the water with a sieve or screen that captured the oil/polymer mixture but allowed the water to flow through. Polyethylene was added to the oil layer until all the visible oil was removed from the water. The weight ratio of polyethylene to oil required to remove all the visible oil was about 1.5 to 1.

### EXAMPLE 2

The procedure described in Example 1 was repeated by using salt water from the Gulf of Mexico instead of fresh water. All the visible oil was removed from the water.

### EXAMPLE 3

The procedure described in Example 2 was repeated by using diesel fuel instead of motor oil. All the visible oil was removed from the water.

### EXAMPLE 4

The procedure described in Example 2 was repeated by using petroleum crude oil instead of motor oil. All the visible oil was removed from the water.

### EXAMPLE 5

The procedure described in Example 2 was repeated by using a fine particle paraffin wax (99% thru a 10 mesh) with a melt point of about 135° F. instead of the polyethylene powder. The paraffin quickly absorbed the oil at a weight ratio of 0.5 parts of paraffin to 1.0 parts of oil and also formed an easily removable mixture. All the visible oil was removed from the water.

### EXAMPLE 6

The procedure described in Example 2 was repeated by using a fine particle polystyrene powder (99% thru a 10 mesh) instead of the polyethylene powder. The polystyrene polymer removed the oil at a weight ratio of 1.0 part of polystyrene to 1.0 part of oil and also formed an easily removable mixture. All the visible oil was removed from the water.

### EXAMPLE 7

The procedure described in Example 2 was repeated by using a blend of the paraffin wax used in Example 5 and polyethylene powder used in Example 2 instead of the polyethylene powder. Fine particle of the blend powder (99% thru a 10 mesh) at a weight ratio of 1.0 part of blend to 1.0 part of oil formed an easily removable mixture. All the visible oil was removed from the water.

While the invention is described with respect to specific embodiments, modifications thereof can be made by one skilled in the art without departing from the spirit of the invention. The details of said embodiments are not to be construed as limitations except to the extent indicated in the following claims.

What is claimed is:

1. A process for removing an oily substance from an aqueous medium that contains the oily substances, comprising the steps of:
contacting the oily substance with a lipophilic and oil-absorbing polymeric composition;
forming a mixture containing the polymeric composition and the oily substance; and
separating the mixture from the aqueous medium.

2. The process according to claim 2 wherein the mixture is in the form of a defined pasty material that floats in water.

3. The process according to claim 1 further including the step of skimming the material.

4. The process according to claim 1 wherein the polymeric composition is hydrophobic low molecular weight polymer.

5. The process according to claim 1 wherein the polymeric composition is a hydrophobic waxes.

6. The process according to claim 1 wherein the polymeric composition has a polymer backbone of a weight average molecular weight in the range from 100 to 6,000,000.

7. The process according to claim 1 wherein the polymeric composition has a polymer backbone of a weight average molecular weight in the range from 250 to 100,000.

8. The process according to claim 1 wherein the polymeric composition has a melting point of less than 200° C.

9. The process according to claim 1 wherein the polymeric composition has a surface to volume ratio greater than 3.0.

10. The process according to claim 1 wherein the polymeric composition has the ability to absorb and/or adsorb at least 20 weight percent of an oily substance based on the total weight of the polymeric composition.

11. The process according to claim 1 wherein the polymeric composition is in ground or powder form prior to contacting it with the oily substance.

12. The process according to claim 1 wherein the polymeric composition has a size in the range between 325 mesh and 6 mesh.

13. The process according to claim 1 wherein the polymeric composition is polyethylene.

14. The process according to claim 1 wherein the polymeric composition is a paraffin wax.

15. The process according to claim 1 wherein the polymeric composition is polystyrene.

16. The process according to claim 1 wherein the polymeric composition is a mixture of polyethylene and paraffin wax.

17. The process according to claim 1 wherein the polymeric composition is a mixture of polyethylene and polystyrene.

18. A process for removing a hydrophobic material from an aqueous medium that contains the hydrophobic material, comprising the steps of:
contacting the hydrophobic material with a lipophilic and hydrophobic material absorbing polymeric composition;
forming a mixture containing the polymeric composition and the hydrophobic material; and
separating the mixture from the aqueous medium.

19. A process for remediating an aqueous medium that has been contaminated with an oily substance, comprising the steps of:
contacting the oily substance with a lipophilic and oil-absorbing polymeric composition;
forming a mixture containing the polymeric composition and the oily substance;
separating the mixture from the aqueous medium; and
processing the separated mixture to obtain reusable products

20. The process according to claim 19 wherein the processing step is carried out in a refinery.
